(19) United States
(12) Patent Application Publication
(10) Pub. No.: US 2002/0061687 A1
(43) Pub. Date: May 23, 2002

(54) Solder bearing grid array

(75) Inventors: Joseph S. Cachina, Warwick, RI (US); James R. Zanolli, North Smithfield, RI (US)

Correspondence Address: DARBY & DARBY P.C., 805 Third Avenue, New York, NY, 10022, US

(73) Assignee: TEKA INTERCONNECTIONS SYSTEMS, INC.

(21) Appl. No.: 09/991,055

(22) Filed: Nov. 21, 2001

Related U.S. Application Data
(60) Provisional application No. 60/252,433, filed on Nov. 21, 2000.

(51) Int. Cl. H01R 4/02

(52) U.S. Cl. 439/874

(57) ABSTRACT

The present invention provides a solder ball grid array (SBGA) type connector and method of manufacture thereof. The SBGA connector includes a number of contacts which each have a solder ball formed at one end thereof. According to the present invention the solder ball is formed by disposing and retaining a solder mass along a body of the contact. The contact is then heated to a predetermined temperature resulting in the solder mass reflowing to one end of the body so that a solder ball is formed at the one end.

### CROSS REFERENCE TO RELATED APPLICATION

This application claims the benefit of U.S. Application Serial No. 60/252,433, filed Nov. 21, 2000, which is hereby incorporated by reference in its entirety.

### FIELD OF THE INVENTION

The present invention relates to the field of devices for joining electrical components to one another and, more particularly, to a method and apparatus for facilitating the soldering of a first electronic device, such as a connector, to a second electronic device, such as a printed circuit board.

### BACKGROUND OF THE INVENTION

It is often necessary and desirable to electrically connect one component to another component. For example, a multi-terminal component, such as a connector, is often electrically connected to a substrate, such as a printed circuit board, so that the contacts or terminals of the component are securely attached to contact pads formed on the substrate to provide an electrical connection therebetween. One preferred technique for securely attaching the component terminals to the contact pads is to use a solder material.

In the mounting of an integrated circuit (IC) on a substrate (e.g., formed of a plastic or a ceramic), the use of ball grid array (BGA) or other similar packages has become common. In a typical BGA, spherical solder balls attached to the IC package are positioned on electrical contact pads of a circuit substrate to which a layer of solder paste has been applied. The solder paste is applied using any number of techniques, including the use of a screen or mask. The unit is then heated to a temperature at which the solder paste and at least a portion or all of the solder balls melt and fuse to an underlying conductive pad formed on the circuit substrate. The IC is thereby connected to the substrate without need of external leads on the IC.

The BGA concept also offers significant advantages in speed, density, and reliability and as a result, the BGA package has become the packaging option of choice for high performance semiconductors. The inherent low profile and area array configuration provide the speed and density and the solid solder spheres provide enhanced solder joint reliability. Reliability is enhanced because the solder joints occur on a spheroid shape of solid solder. The spheroid shape, when properly filleted, provides more strength than flat or rectangular shaped leads of equivalent area. The solid solder composition provides a more reliable solder joint than conventional stamped and plated leads because there can be no nickel underplate or base metal migration to contaminate or oxidize the solderable surface, or weak intermetallic layers than can form when the solder bonds to a nickel underplate. Further, tin and tin plating processes used on conventional stamped and plated leads have additives than can inhibit solderability. Enhanced solder joint reliability is particularly important to an area array package because the solder joints cannot be visually inspected.

While the use of a BGA connector in connecting the IC to the substrate has many advantages, there are several disadvantages and limitations of such devices. It is important for most situations that the substrate-engaging surfaces of the solder balls are coplanar to form a substantially flat mounting interface so that in the final application, the solder balls will reflow and solder evenly to the planar printed circuit board substrate. If there are any significant differences in solder coplanarity on a given substrate, this can cause poor soldering performance when the connector is reflowed onto a printed circuit board. In order to achieve high soldering coplanarity, very tight coplanarity requirements are necessary. The coplanarity of the solder balls is influenced by the size of the solder balls and their positioning on the connector.

Conventional BGA connector designs attach loose solder balls to the assembled connector. The attachment process requires some type of ball placement equipment to place solder balls on a contact pad or recessed area of the connector that has been applied with a tacky flux or solder paste. The connector then goes through a reflow oven to solder the balls to the contact. The process is slow, sensitive, and requires expensive, specialized equipment.

An example of a BGA type connector is described in U.S. Pat. No. 6,079,991, ('991) to Lemke et al., which is herein incorporated by reference in its entirety. The connector includes a base section having a number of outer recesses formed on an outer surface of the base section. Similarly, the base section also has a number of inner recesses formed on an inner surface of the base section. The inner recesses are designed to receive contacts and the outer recesses are designed to receive solder balls so that the solder balls are fused to bottom sections of the contacts which extend into the outer recesses. The contacts comprise both ground/power contacts and signals contacts with top sections of the contacts providing an electrical connection with an electronic device by known techniques. Another electronic device, e.g., a PCB, is electrically connected to the contacts by soldering the solder balls onto contacts formed on the PCB, thereby providing an electrical connection between the two electronic devices.

While the '991 connector is suitable for use in some applications, it suffers from several disadvantages. First, the connections between the solder balls and the bottom sections of the contacts may lack robustness and durability since the solder balls are simply placed in the outer recesses and then reflowed to form the electrical connection between the contact and one electronic device. Accordingly, only a portion of each solder ball is in contact with the bottom section of one contact before and after the soldering process. Second, because the solder balls are simply inserted into the outer recesses, the solder balls may not be coplanar with one another during the use of the connector and during the reflow process. Another disadvantage of this type of connector is that the solder joints are especially susceptible to fracturing during thermal expansion and cooling. The base section and the printed circuit board typically each has a different coefficient of thermal expansion and therefore when both are heated, one component will expand greater than the other. This may result in the solder joint fracturing because the solder ball is confined within the outer recess and the movement of the end of the contact to which the solder ball is attached is limited due to housing constraints. In other words, the contact is held in place within the housing substrate and only slightly protrudes into the recess where the solder ball is disposed. The contact therefore is effectively held rigid and not permitted to move during the reflow process.

In addition, the costs associated with manufacturing the '991 connector are especially high since the contacts must be placed in the base section and then the individual solder balls must be placed within the outer recesses formed in the base section. A BGA type connector likely includes hundreds of solder balls and thus, the process of inserting individual solder balls into the outer recesses requires a considerable amount of time and is quite costly.

It is therefore desirable to provide an alternative device and method for mounting high density electrical connectors on substrates, e.g., PCBs, by surface mounting techniques, e.g., using a ball grid array type connector.

### SUMMARY OF THE INVENTION

According to a first embodiment, a solder ball grid array connector (SBGA) is provided for electrically connecting a first electronic device to a second electronic device. The connector includes a predetermined number of contacts which are disposed within a substrate according to a predetermined arrangement. According to the present invention, each contact is formed so that a solder ball is formed at one end of the contact. In one exemplary embodiment, the contact is a solder-bearing lead contact having a feature for retaining a solder mass along a portion of the contact body. For example, a claw-like structure may be formed on the body to hold and retain the solder mass. The contact is then subjected to a first reflow operation, whereby the solder mass reflows and forms itself into a spheroid shape at one end of the contact. The resultant spheroid shape is solid solder in composition and acts as a solder ball with the same advantages as a conventional solder ball grid array configuration.

The contacts may then be conveniently and easily disposed within openings formed in the substrate and the coplanarity of the solder balls is controlled so that substrate-engaging surfaces of the solder balls are coplanar to form a substantially flat mounting interface.

An opposite end of each contact is designed to separably connect to a terminal (contact) of the first electronic device and the solder ball formed at the end of the contact is disposed relative to a corresponding contact of the second electronic device. Preferably, the second electronic device is a printed circuit board and the contacts of the device are surface mount contact pads. Accordingly, each solder ball is disposed proximate to and preferably in intimate contact with one surface mount contact pad prior to subjecting the connector to a second reflow operation. In the second reflow operation, each solder ball is heated so that the solder material flows onto and provides a secure electrical connection with the corresponding surface mount contact pad.

The connector of the present invention provides numerous advantages over conventional BGA connectors. For example, the connector of the present invention is a lower cost product that offers superior design and reliability compared to conventional devices. By eliminating the time intensive solder ball attachment process, the manufacturing cost and time are reduced. Quality and reliability are enhanced because the solder balls of the present connector are intimate and positive to the parent contact and lead coplanarity is improved and is more consistent. In another aspect of the present invention, the connector provides a compliant lead.

The above-discussed and other features of the present invention will be appreciated and understood by those skilled in the art from the following detailed description and drawings.

### BRIEF DESCRIPTION OF THE DRAWINGS

Objects and features of the present invention will be described hereinafter in detail by way of certain preferred embodiments with reference to the accompanying drawings, in which:

FIG. 1 is a top planar partial view of one exemplary type of solder-bearing contact prior to receiving a solder mass;

FIG. 2 is a top planar view of the solder-bearing contact of FIG. 1 in a formed orientation;

FIG. 3 is a side elevational view of the solder-bearing contact of FIG. 2;

FIG. 4 is a side elevational view of the solder-bearing contact of FIG. 2 with the solder mass being received within a retaining feature of the contact;

FIG. 5 is a bottom planar view of the solder-bearing contact of FIG. 4 after the solder mass has been cut into a segment;

FIG. 6 is a top planar view of the solder-bearing contact of FIG. 5 after the solder mass has been compacted and prior to subjecting the contact to a first reflow operation;

FIG. 7 is a side elevational view of the solder-bearing contact of FIG. 6;

FIG. 8 is a top planar view of the solder-bearing contact of FIG. 6 after performing the first reflow operation in which the solder material reflows to form a solder ball in accordance with the present invention;

FIG. 9 is a side elevational view of the solder-bearing contact of FIG. 8;

FIG. 10 is a side elevational view of one exemplary connector assembly, wherein a plurality of solder-bearing contacts of FIG. 8 are disposed in a connector housing to provide an electrical connection between two electronic devices, partially shown; and

FIG. 11 is a side elevational view of the connector assembly of FIG. 10 after the solder-bearing contacts have been subjected to a second reflow operation.

### DETAILED DESCRIPTION OF THE PREFERRED EMBODIMENT

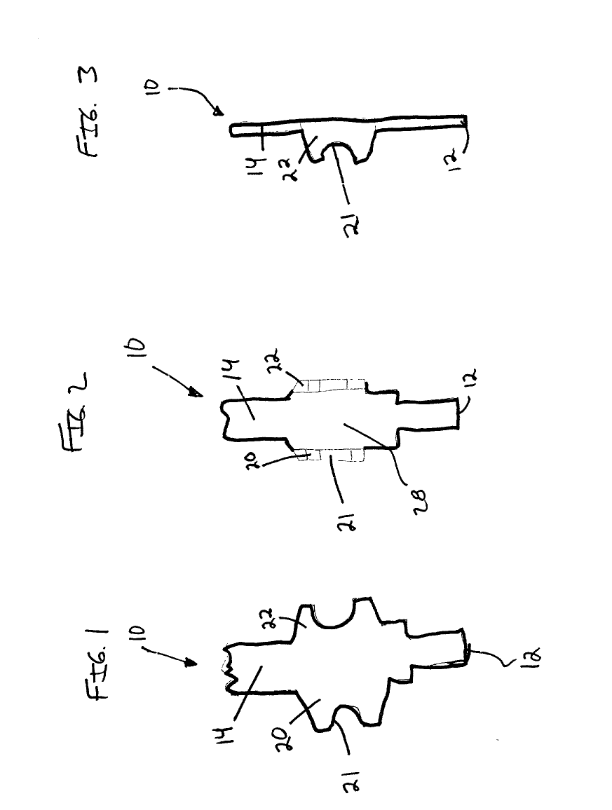

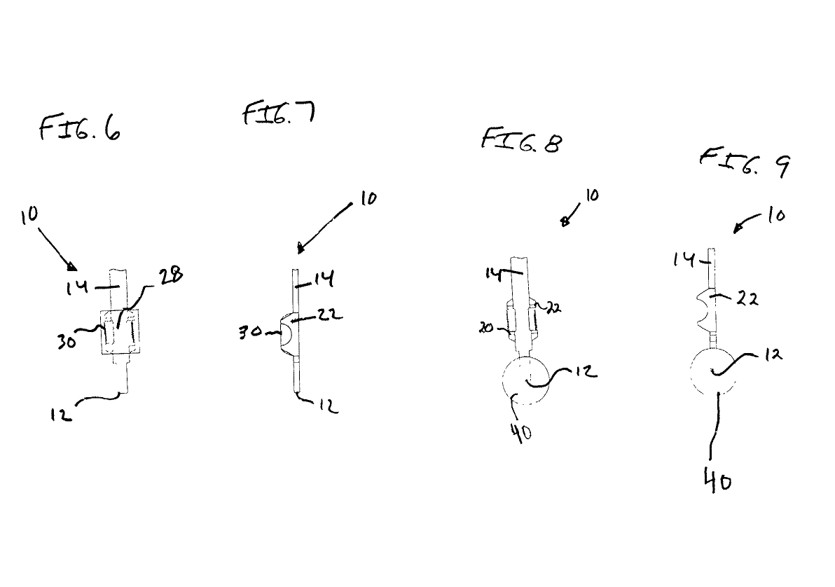

Referring to FIGS. 1-7, one exemplary solder-bearing contact (lead) is partially shown and indicated at 10. For purpose of simplicity, the solder-bearing contact 10 is only partially shown; however, it will be appreciated that any number of suitable electrical contacts may be used in practicing the present invention. Solder-bearing contact 10 is merely exemplary in nature and is not limiting of the present invention. The solder-bearing contact 10 includes a first end 11 (FIG. 11) which forms a separable electrical connection with a first electronic device 200 (FIG. 10) and an opposing second end 12. The solder-bearing contact 10 has an elongated body 14 which terminates at one end with the second end 12.

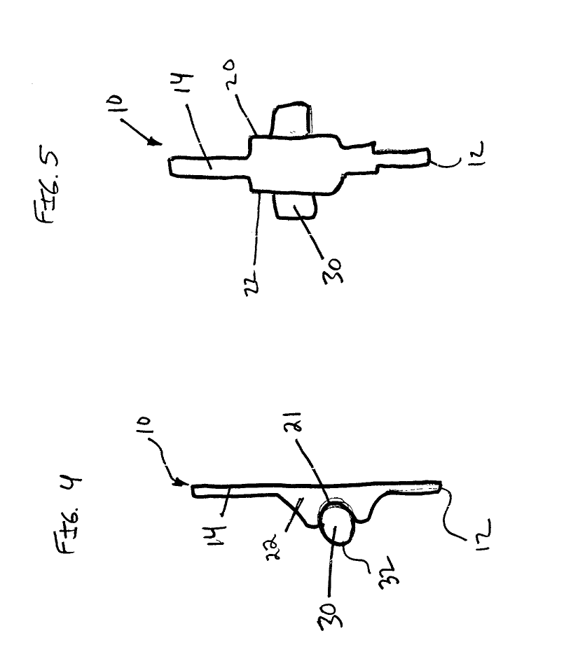

As shown in FIG. 1, the exemplary solder-bearing contact 10 is initially in a first cut position in which opposing first and second tabs 20, 22 extend outwardly from lateral edges of the elongated body 14. The first and second tabs 20, 22 are preferably in the form of extensions which protrude from the lateral edges of the elongated body 14. The solder-bearing contact 10 is formed of any number of suitable conductive materials, e.g., a metal, and may be formed using any number of known techniques. For example, the solder-bearing contact 10 may be formed using a stamping process. In this first cut position, the solder-bearing contact 10, including the first and second tabs 20, 22, is generally planar. FIGS. 2 and 3 illustrate the solder-bearing contact 10 in a second formed position in which the first and second tabs 20, 22 are bent upwardly so that a portion of the first and second tabs 20, 22 is bent out of the plane and lies in a plane which intersects the plane containing the planar body 14. Preferably, the first and second tabs 20, 22 are bent so that the tabs 20, 22 upwardly protrude from lateral edges of the body 14 and more preferably, the first and second tabs 20, 22 are generally perpendicular to the body 14.

Each of the first and second tabs 20, 22 includes a cut-out 21 formed therein. In the illustrated embodiment, the cut-out 21 is generally arcuate in shape and when the first and second tabs 20, 22 are bent upwardly, the cut-outs 21 preferably axially align with one another. Each of the first and second tabs 20, 22 comprises a gripping member which is designed to grip and hold a solder mass 30 (FIG. 4), e.g., solder wire segment. A gap is formed between the first and second tabs 20, 22 and is designed to receive the solder mass 30 once the solder mass 30 is compacted as will be described hereinafter.

The cut-outs 21 are dimensioned to have a width substantially equal to the width of the solder mass 30, which is typically in the form of a piece of solder wire to be laid therein. For holding the solder mass 30 to the elongated body 14, the first and second tabs 20, 22 are bent out of the plane of the elongated body 14 as shown in FIGS. 2 and 3, thereby providing a channel 28. The channel 28 thus is defined by a “floor” formed by the elongated body 14 and the edges of the first and second tabs 20, 22.

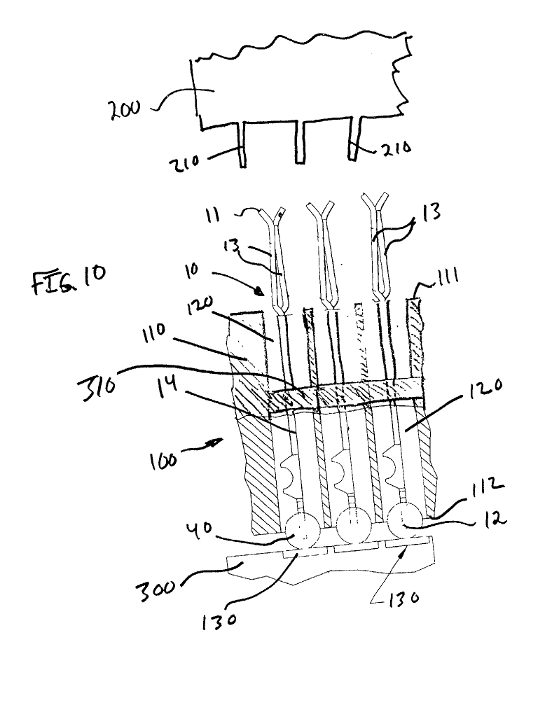

As shown in FIG. 4, the solder mass 30 is first laid across the body 14 within the cut-outs 21. Preferably, the solder mass 30 is dimensioned so that a frictional fit results between the solder mass 30 and the cut-outs 21. Because of the shape and function of the cut-outs 21, this type of structure is often referred to as a “claw” configuration. The solder mass 30 initially will likely extend above the tabs 20, 22 so that the solder mass 30 has an exposed surface 32. After the solder mass 30 is positioned within the cut-outs 21, and either before or after it is cut into appropriate section lengths, the solder mass 30 is compacted using conventional techniques. FIGS. 6 and 7 illustrate the solder mass 30 in a compacted condition. The compacted solder mass 30 fills out the channel 28 and is thereby retained physically to the elongated body 14. The solder mass 30 in this compacted condition, preferably extends only slightly, if at all, above the upper edges of the tabs 20, 22. In this condition, the solder mass 30 nearly fills the channel 28 and offers a lower profile.

It being understood that the method of retaining the solder mass 30 along the elongated body 14 is merely exemplary in nature and there are any number of other methods for retaining the solder mass 30 along the elongated body 14. For example, another method is disclosed in commonly assigned U.S. Pat. No. 4,679,889, to Seidler, which is hereby incorporated by reference in its entirety. The use of first and second tabs 20, 22, as shown in FIGS. 1-7 is thus merely exemplary in nature and does not serve to limit the present invention.

The first end 11 (FIG. 10) of the elongated body 14 includes a feature which permits the first electronic device 200 to be separably connected to the solder-bearing contacts 10 at the first ends 11 thereof. For example, the first end 11 may include a pair of biased contacting forks 13 (FIG. 10) which receive a terminal 210 (FIG. 10) of the first electronic device 200 (FIG. 10). The terminal 210 (FIG. 10) may be forcibly received between the contact forks 13 (FIG. 10) to provide an electrical connection between the terminal and the solder-bearing contact 10. It will be understood that the first end 11 (FIG. 10) may include other types of connecting mechanisms for providing the electrical connection between the first electronic device 200 (FIG. 10) and the solder-bearing contact 10.

It will also be appreciated that the solder-bearing contact 10 may be a ground or power contact or may be a signal contact. In other words, a connector 100 (shown in FIG. 10) of the present invention includes ground or power contacts along with signal contacts as is known in the art. The permits the connector 100 (FIG. 10) to be used in connecting any number of electronic devices to one another. The solder-bearing contact 10 is formed from any number of suitable conductive materials, e.g., a metal. The melting point of the material forming the solder-bearing contact 10 is preferably greater than a solder reflow temperature of the solder material.

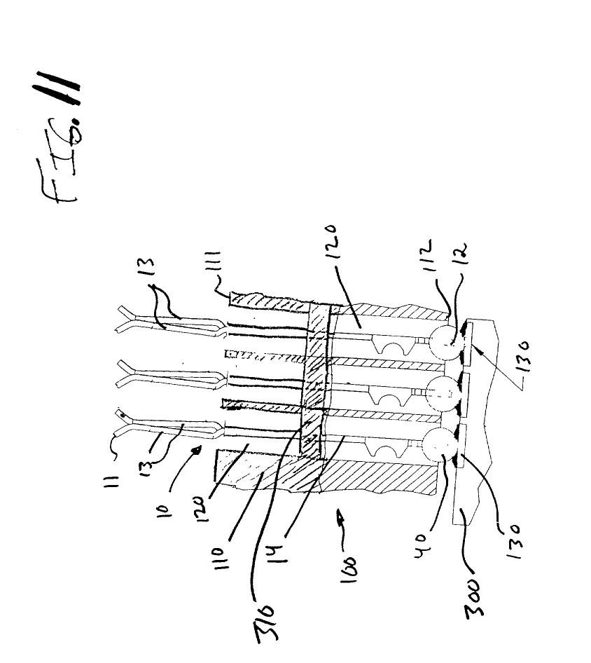

Referring now to FIGS. 1-9, according to the present invention, the solder ball grid array connector 100 and method of manufacture thereof are provided. According to the present invention, a solder ball, generally indicated at 40, is formed from the solder mass 30 by subjecting the contact 10 to a first reflow operation. First a predetermined number of solder-bearing contacts 10 are formed using conventional techniques previously-mentioned. The solder mass 30 is retained along the body 14 by a retaining feature, such as the “claw” configuration shown in FIGS. 1-7. The solder-bearing contacts 10 are then heated to solder reflow temperatures so that each solder mass 30 (solder wire segment) forms itself into the spheroid shape and thus forms one solder ball 40, as shown in FIGS. 8 and 9. The resultant spheroid shape will be solid solder in composition and will provide the same advantages as conventional BGA configurations.

Thus, one solder ball 40 is formed at the second end 12 of each solder-bearing contact 10 as a result of the first reflow operation. According to one aspect of the present invention and as shown in FIGS. 8 and 9, the second end 12 of the elongated body 14 is embedded in the solder ball 40. This provides advantages over conventional BGA devices as will be explained in greater detail hereinafter.

The first reflow operation can be done as a continuous reel-to-reel process. The heat can be provided by any number of conventional techniques, including but not limited to providing heat using a conventional SMT (surface mount technique) oven, hot air, a focused infrared (IR) beam, a laser, or hot oil. The solder-bearing contact 10 is subjected to the first reflow operation such that the solder mass 30 is heated and flows into a spheroid shape (solder ball 40) and does not wick up on the elongated body 14 during the operation. In other words, the thermodynamics of the process is such that the solder mass 30 is transformed into the spheroid shape (solder ball 40) without wicking up on the elongated body 14 as the spheroid shape is formed. This may be accomplished in a number of ways. For example, the solder motion may be influenced by a profiling process in which the surface of the contact 10 is profiled such that during the first reflow operation, the solder mass 30 flows toward the second end 12 where it forms the solder ball 40. In other words, the contact 10 may be configured so that the second end 12 reaches higher temperatures quicker than the other areas of the contact 10 causing the solder material to flow towards the second end 12.

Another manner of influencing the flow of the solder mass 30 is to tailor the thermodynamic conditions of the contact 10. Desired thermodynamic conditions may be provided by skiving in a solder stop before final form and attachment of the solder mass 30 to the contact 10. This influences the solder motion by causing the second end 12 to reach a higher temperature quicker than the other portions of the contact 10 and the contact 10 is further tailored so that the solder mass 30 flows to the second end 12 to form the solder ball 40. It will be appreciated that a profiling process may be used in combination with or separately from a skiving process or other similar process.

FIG. 10 illustrates one exemplary ball grid array connector 100 having a predetermined number of solder-bearing contacts 10 arranged in a predetermined pattern. The connector 100 generally includes a substrate 110 having a first surface 111 and an opposing second surface 112. Preferably, the substrate 110 is a generally planar member so that the first surface 111 and the second surface 112 are planar surfaces substantially parallel to one another. The substrate 110 has a plurality of openings 120 formed therein to receive the solder-bearing contacts 10. The openings 120 permit the solder-bearing contacts 10 to extend through the substrate 110 so that the first end 11 preferably protrudes above the first surface 111 to permit the first end 11 to be separably connected to terminals or the like 210 of the first electronic device 200. The second end 14 is designed to mate with a second electronic device 300 to provide an electrical connection between contacts 130 (e.g., surface mount solder pads) of the second electronic device 300 and the solder balls 40. It will be appreciated that the openings 120 have a width which is greater than the diameter of the solder balls 40, thereby permitting the solder balls 40 to be disposed within openings 120.

In the illustrated exemplary embodiment shown in FIG. 10, the second ends 12 of the solder-bearing contacts 10 slightly extend beyond the second surface 112. This results in the solder balls 40 being partially disposed within the openings 120 and partially extending beyond the substrate 110. The solder-bearing contacts 10 may have other orientations so long as the solder balls 40 are positioned so that they may engage the contacts 130 of the second electronic device 300. The solder-bearing contacts 10 are retained within the openings 120 by any number of techniques. For example, a longitudinal support member 310 may extend across each opening 120 with an opening being formed therein to frictionally receive one solder-bearing contact 10 such that the solder-bearing contact 10 is retained in place. The opening formed in the longitudinal support member 310 is actually part of the opening 120 formed through the substrate 110.

According to the present invention, the solder balls 40 are preferably formed in a continuous reflow process (first reflow operation) which results in the solder balls 40 being formed on the substantial number of solder-bearing contacts 10 which are typically used in one connector 100. This is a substantial improvement over the conventional process of forming solder balls 40. As earlier indicated, the previous manner of forming BGA connectors was to individually insert solder balls into recesses or the like. This is a very time intensive and costly process due to the typical BGA connector including many contacts which each require an individual solder ball. In contrast, the present invention permits the solder balls 40 to be formed during the overall process of manufacturing the solder-bearing contacts 10. Solder masses 30 are disposed within the “claw” structure of the solder-bearing contacts 10 and then during a first reflow operation, the solder balls 40 are formed from the solder masses 30.

FIG. 10 shows the connector 100 in a position just prior to a final reflow operation (second reflow operation) which serves to provide a solid electrical connection between the contacts 130 and the solder-bearing contacts 10, more specifically, the solder balls 40 thereof. In this position, each solder ball 40 is disposed proximate to and preferably in contact with one contact 130. To provide an electrical connection between the first electronic device 200 and the second electronic device 300, the first end 11 of each of the solder-bearing contacts 10 is separably connected to the first electronic device 200. For example, the first electronic device 200 may include a number of spaced terminals or contact plates or the like 210 which are releasably inserted between the biased forks 13 of the solder-bearing contacts 10 to provide an electrical connection between the first end 11 of each solder-bearing contact 10 and the corresponding terminal or contact 210 of the first electronic device 200.

An electrical connection is formed between each solder ball 40 and one respective contact 130 of the second electronic device 300 by subjecting the connector 100 to the second reflow operation. In the second reflow operation, the solder balls 40 are heated to a reflow temperature which causes the solder balls 40 to reflow onto the contacts 130. In the instance that the contacts 130 also include a layer of solder material, the second reflow operation causes the solder material to reflow as the solder balls 40 reflow. It will be understood that during the second reflow operation, the second ends 12 of the solder-bearing contacts 10 are still embedded within solder material. Upon completion of the second reflow operation, the solder material is permitted to cool. The result is that a secure, solid electrical connection is formed between the solder-bearing contacts 10 and the contacts 130 of the second electronic device 300 by means of the solder balls 40 which act as a conductive bridge therebetween. FIG. 11 shows the connector 100 and the second electronic device 300 after the solder balls 40 have undergone the second reflow operation and have cooled. For illustration purposes only, the first electronic device 200 is not shown in FIG. 11. It will be understood that the solder balls 40 may or may not significantly deform during the second reflow operation, depending upon the precise application and operations conditions so long as a secure connection results between each solder ball 40 and one contact 130.

The connector 100 of the present invention offers a number of advantages over conventional BGA connectors, such as the one disclosed in the previously-mentioned U.S. Pat. No. 6,079,991. The electrical connection formed between the solder ball 40 and the contact 130 is more durable and more robust compared to similar connections in conventional devices because the second end 12 of each contact 10 is embedded within the solder ball 40 prior to and after the second reflow operation, which provides the electrical connection between the solder-bearing contact 10 and the contact 130. In comparison, the solder balls used in conventional devices are simply inserted into a recess formed in a substrate of the connector so that a portion of the solder ball rests against one end of one contact. The end of the contact is not embedded within the solder ball and thus during the final reflow operation, the solder ball reflows around only a tip portion of the end of the contact. This may result in less than ideal fusing and robustness between the contact and the solder ball.

During the use of a conventional BGA connector, the physical connection between the contact and the solder ball may fracture resulting in a less than optimum electrical connection formed therebetween because of the fusing characteristics of the solder ball. In contrast, the present invention offers a more durable and robust electrical connection between the solder ball 40 and the second end 12 of the solder-bearing contact 10 because the second end 12 is embedded within the solder ball 40.

In addition, the connector 100 of the present invention offers improved coplanarity of the solder balls 40. It is important for most situations that the substrate-engaging surfaces of the solder balls 40 are coplanar to form a substantially flat mounting interface, so that in the final application, the solder balls 40 reflow and solder evenly to the second electronic device 300, which preferably is in the form of a planar printed circuit board substrate. Because the solder balls 40 are preferably formed as part of the process of manufacturing the solder-bearing contacts 10, the coplanarity of the solder balls 40 in the connector 100 is better controlled. The solder-bearing contacts 10 are inserted and retained within the openings 120 of the substrate 110 in such a manner such that the substrate-engaging surfaces of the solder balls 40 are coplanar. In comparison, conventional devices suffered from the disadvantage that often times, the solder balls were not coplanar resulting in poor soldering performance when the connector is reflowed onto the printed circuit board.

Furthermore, the present invention provides a compliant lead because the likelihood that the solder joints will fracture is reduced in comparison with the solder joint configurations of conventional devices. Conventional BGA connector designs result in a construction whereby there is no compliancy to the joint or lead. For example, in some of the conventional devices, the solder balls are retained within recesses formed in the substrate of the connector, and the solder joints are apt to fracture as the components are heated and then cooled because the printed circuit board has a different coefficient of thermal expansion compared to the connector. This difference causes one of these components to expand relative to the other one and can cause fracturing of the solder joints because the solder balls are confined within the recesses of the substrate.

The contact 10 is designed to take up the thermal expansion which results during heating of the second electronic device 300 and the connector 100 due to the difference between the coefficients of thermal expansion for each of these components. Unlike in conventional BGA connectors, the contacts 10 of the connector 100 have a range of motion because of their positioning within the substrate 110. As shown in FIG. 10, the second end 12 of the contact 10 is disposed in the exemplary substrate 110 so that the second end 12 is permitted movement within the opening 120. The second end 12 has a range of movement because it is not constrained within an opening formed in the substrate housing as in conventional connectors. Thus, during the second reflow operation, the contact 10 is permitted some range of motion and is designed to take up the thermal expansion. Accordingly, a more compliant lead is provided.

Furthermore, the connector 100 permits a flux material to be applied to the exterior of the solder ball 40 subsequent to the first reflow operation. The flux material may be applied using any number of techniques, including but not limited to an immersion process. Because the solder balls used in conventional connectors needed to be handled in order to disposed the balls within the recesses formed in the substrate, the application of a flux material was not practical. In contrast, the solder balls 40 of the present connector 100 do not need to be handled prior to the second reflow operation and therefore, a flux material may be applied to the solder balls 40 after the balls 40 have been formed. Also, the connector of the present invention is more cost effective because the elimination of the solder ball attach process reduces overall cost and manufacturing time.

Although a preferred embodiment has been disclosed for illustrative purposes, those skilled in the art will appreciate that many additions, modifications and substitutions are possible without departing from the scope and spirit of the invention.

What is claimed is:

1. A method of forming a contact comprising the steps of:
providing the contact, the contact having a body;
disposing and retaining a solder mass along the contact body;
heating the contact to a predetermined temperature resulting in the solder mass reflowing to one end of the body so that a solder ball is formed at the one end; and
cooling the contact.

2. The method of claim 1, wherein the solder mass extends transversely across the contact body and is grippingly retained by one or more features formed on the contact body.

3. The method of claim 1, wherein the one or more features comprise a pair of spaced tabs which protrude from lateral edges of the contact body.

4. The method of claim 3, wherein each of the spaced tabs includes an arcuate cut-out for receiving the solder mass such that the solder mass seats within the spaced cut-outs and extends transversely across the contact body.

5. The method of claim 1, wherein the solder mass is retained at a location along the contact body above the one end so that upon heating the contact, the solder mass flows gravitationally to the one end and forms the solder ball thereat.

6. The method of claim 1, wherein the contact is part of a solder ball grid array connector.

7. A method of forming a contact comprising the steps of:
providing the contact, the contact having a body with first and second tabs protruding beyond lateral edges of the contact body, the contact body including the first and second tabs being generally planar in a first position;
bending the first and second tabs to a second position such that the first and second tabs protrude upwardly from the lateral edges of the contact body;
disposing a solder mass within the first and second tabs such that the solder mass is held by the first and second tabs;
heating the contact until the solder mass reflows to one end of the contact body, the reflowing solder mass forming a generally spherical body at the one end; and
cooling the contact to form a solder ball at the one end.

8. The method of claim 7, further including the step of:
compacting the solder mass after it has been disposed within the first and second tabs, the compacting causing the solder mass to directed into a channel formed between the first and second tabs and into contact with the contact body that defines a floor of the channel.

9. The method of claim 7, wherein the solder mass is retained at a location along the contact body above the one end so that upon heating the contact, the solder mass flows gravitationally to the one end and forms the solder ball thereat.

10. The method of claim 7, wherein the contact is part of a solder ball grid array connector.

11. The method of claim 7, wherein the solder mass is a solder mass segment.

12. A method of forming a solder ball grid array connector, the method comprising the steps of:
providing a solder ball grid array connector substrate having a plurality of openings formed therein; and
inserting one contact into each of the openings formed in the substrate, the contact being formed by:
providing a contact body;
disposing and retaining a solder mass along the contact body;
heating the contact to a predetermined temperature resulting in the solder mass reflowing to one end of the body so that a solder ball is formed at the one end; and
cooling the contact resulting in the solder ball being formed at the one end.

13. The method of claim 12, wherein the solder mass extends transversely across the contact body and is grippingly retained by one or more features formed on the contact body.

14. The method of claim 12, wherein the one or more features comprise a pair of spaced tabs which protrude from lateral edges of the contact body.

15. The method of claim 14, wherein each of the spaced tabs includes an arcuate cut-out for receiving the solder mass such that the solder mass seats within the spaced cut-outs and extends transversely across the contact body.

16. The method of claim 12, wherein the solder mass is retained at a location along the contact body above the one end so that upon heating the contact, the solder mass flows gravitationally to the one end and forms the solder ball thereat.
